(19) United States
(12) Patent Application Publication
(10) Pub. No.: US 2018/0336525 A1
(43) Pub. Date: Nov. 22, 2018

(54) HYBRID OFFLINE/ONLINE GENERATION OF JOB RECOMMENDATIONS

(71) Applicant: LinkedIn Corporation, Sunnyvale, CA (US)

(72) Inventors: Krishnaram Kenthapadi, Sunnyvale, CA (US); Parul Jain, Cupertino, CA (US); Jian Wang, Los Altos, CA (US)

(21) Appl. No.: 15/596,765

(22) Filed: May 16, 2017

(51) Int. Cl. G06Q 10/10; G06Q 50/00

(52) U.S. Cl. CPC G06Q 10/1053; G06Q 50/01

(57) ABSTRACT

A recommendation system is configured to perform some operations related to recommending jobs to a member after the member has logged in into the online social network system, and also configured to perform some of the operations related to recommending jobs preemptively, prior to detecting an indication that the member is logged in. The elements of the recommendation system that perform operations offline are termed an offline ranker. The elements of the recommendation system that perform operations online are termed an online ranker. The online ranker uses the values pre-computed by the offline ranker in selecting job postings to be recommended to a member represented by a subject member profile.

### TECHNICAL FIELD

This application relates to the technical fields of software and/or hardware technology and, in one example embodiment, to system and method to generate job recommendations using hybrid offline/online approach in an online social network system.

### BACKGROUND

An online social network may be viewed as a platform to connect people and share information in virtual space. An online social network may be a web-based platform, such as, e.g., a social networking web site, and may be accessed by a use via a web browser or via a mobile application provided on a mobile phone, a tablet, etc. An online social network may be a business-focused social network that is designed specifically for the business community, where registered members establish and document networks of people they know and trust professionally. Each registered member profile may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An online social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate job recommendations using hybrid offline/online approach in an online social network system may be implemented;

FIG. 2 is block diagram of a system to generate job recommendations using hybrid offline/online approach in an online social network system, in accordance with one example embodiment;

FIG. 3 is a flow chart illustrating a method to generate job recommendations using hybrid offline/online approach in an online social network system, in accordance with an example embodiment;

FIG. 4 is a diagrammatic representation of an example machine in the form of a computer system within which a set of instructions, for causing the machine to perform any one or more of the methodologies discussed herein, may be executed; and

FIG. 5 is a block diagram illustrating some elements of an offline ranker, in accordance with an example embodiment.

### DETAILED DESCRIPTION

A method and system to generate job recommendations using hybrid offline/online approach in an online social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an online social networking application,” “an online social network system,” and “an online social network service” may be referred to as and used interchangeably with the phrase “an online social network” or merely “a social network.” It will also be noted that an online social network may be any type of an online social network, such as, e.g., a professional network, an interest-based network, or any online networking system that permits users to join as registered members. For the purposes of this description, registered members of an online social network may be referred to as simply members.

Each member of an online social network is represented by a member profile (also referred to as a profile of a member or simply a profile). A member profile may include or be associated with links that indicate the member's connection to other members of the social network. A member profile may also include or be associated with comments or recommendations from other members of the online social network, with links to other network resources, such as, e.g., publications, etc. The profile information of a social network member profile may include various information such as, e.g., the name of a member, current and previous geographic location of a member, current and previous employment information of a member, information related to education of a member, etc. The online social network system also maintains information about various companies, as well as so-called job postings. A job posting, also referred to as merely “job” for the purposes of this description, is an electronically stored entity that includes information that an employer may post with respect to a job opening.

The information in a job posting may include, e.g., industry, company, job position, required and/or desirable skills, geographic location of the job, etc. Member profiles and job postings are represented in the online social network system by feature vectors. The features in the feature vectors represent various respective characteristics of the associated job posting or member profile, such as, e.g., a job industry, a professional field, a job title, a company name, professional seniority, geographic location, etc. A characteristic of a member profile may have a corresponding characteristic in a job posting. For example, a member profile often indicates a set of skills possessed by the associated member, which is a characteristic of that member profile. On the other hand, a job posting almost always indicates a set of skills desirable for a job represented by that job posting, which is a characteristic of that job posting that corresponds to the set of skills characteristic in a member profile. A value generated for a pair comprising a member profile and a job posting that indicates the degree of similarity between a characteristic of the member profile and a corresponding characteristic of the job posting is a feature with respect to said pair. A set of features calculated with respect to a pair comprising a member profile and a job posting can be used to determine a value that represents probability of the member represented by the member profile applying for the job represented by the member profile. This value representing said probability is termed a relevance value or a relevance score.

The online social network system includes a recommendation system configured to generate job recommendations for a member as the member logs in, and cause presentation of references to one or more of the recommended jobs on the member's display device. The job postings are selected for recommendation to a particular member based on their respective relevance values generated with respect to the member profile representing that member. For example, those job postings, for which their respective relevance values for a particular member profile are equal to or greater than a predetermined threshold value, are selected for presentation to that particular member, e.g., on the news feed page of the member or on some other page provided by the online social networking system. The relevance values, in one embodiment, are generated using a statistical model (referred to as the relevance model for the purposes of this description).

A recommendation system, in some embodiments, is configured to perform some operations related to recommending jobs to a member after the member has logged in into the online social network system, and also configured to perform some of the operations related to recommending jobs to a member preemptively, prior to detecting an indication that the member logged in into the online social network system. For the purposes of this description, those operations performed with respect to a member profile during periods when the associated member is logged in into the online social network system are referred to as being performed online or at runtime. Those operations performed with respect to a member profile during periods when the associated member is not logged in into the online social network system are referred to as being performed offline. The elements of the recommendation system that perform operations offline are considered to be part of an offline ranker. The elements of the recommendation system that perform operations online are considered to be part of an online ranker. The offline ranker and the online ranker may each utilize one or more distinct relevance models.

In one embodiment, the offline ranker is configured to perform operations that are computationally expensive and/or those operations that are less time-sensitive and store the resulting values to be used, selectively, at run-time, by the online ranker. The online ranker uses the values pre-computed by the offline ranker as relevance scores for determining respective ranks of job postings and also generates respective relevance scores for any job postings that have been added subsequent to the generation of the offline values. The online ranker is also configured to discard or ignore the values pre-computed by the offline ranker with respect to a member profile if it detects changes to the member profile that occurred subsequent to the generation of the offline values.

In some embodiments, the offline ranker precomputes and stores features with respect to a pair comprising a member profile and a job posting, and then the online ranker combines these precomputed features with time-sensitive features online. Examples of features that are less time sensitive and thus could be precomputed offline are content-related features, such as features associated with sets of skills, geographic location, industry type, and seniority. An example of a feature that is more time sensitive is the relative fitness of a particular member for a particular job as compared to respective fitness for that job of the other members.

The hybrid offline/online approach to generating job recommendations for members described herein utilizes the offline and the online models as complementary: the offline model provides richer relevance of results and the online model provides freshness of results. This approach may prove to be beneficial for enabling rapid experimentation and iteration of new feature/model ideas by not requiring the feature/model computation to be implemented/performed online, enabling rich and potentially expensive features (e.g., features computed based on topic models, matrix factorization, concept graph analysis, word embeddings, etc.), beneficial for decoupling modeling efforts from infrastructure changes/limitations, prioritizing and fixing any arising issues in the recommendation system (e.g., updating the skills dictionary and skill extraction for jobs, improving term extraction using external sources, etc.), and also beneficial for guiding infrastructure decisions based on modeling results (for example, determining whether to employ neural networks or random forests).

The offline ranker includes components for collecting data that characterizes member profiles and job postings using internal and external sources. Internal sources are member profiles and job postings. External sources are the data sources that are not part of the online social network system such as, e.g., Wikipedia®. The offline ranker uses the field data extracted from the member profiles and the job postings, in some embodiments together with data obtained from external sources, to generate key concepts for members and jobs. For example, the use of external sources may reveal that the phrase “dentistry” should be treated as equivalent to the phrase “dentist” and should be represented by the same key concept (or, e.g., that that the phrase “patent attorney” should be treated as equivalent to the phrase “patent lawyer” and should be represented by the same key concept) when determining a measure of similarity between a member profile and a job posting. In one embodiment, the offline ranker generates, based on internal and external sources, a universal concept graph that includes a unified and standardized set of concept phrases. In particular, the offline ranker may utilize a linkage structure among the documents (e.g., articles) provided by an external source (e.g., hyperlinks in a given document pointing to one or more other documents) to generated key concepts. A key concept, for the purposes of this description, is a phrase that represents a characteristic of a member profile or a job posting. The offline ranker generates respective sets of key concepts for each member profile and each job posting.

The offline ranker also generates a member inverted index of key concepts where each entry is a key concept mapped to those member profiles that are associated with that key concept. The offline ranker also generates a job inverted index of key concepts where each entry is a key concept mapped to those job postings that are associated with that key concept.

The offline ranker may alsobe configured to generate representations of job postings and member profiles that can be used to define rich features between the fields in member profiles and the fields in job postings. For example, the offline ranker may derive features based on word embedding techniques, which is quantifying and categorizing semantic similarities between linguistic items based on their distributional properties in large samples of language data.

In some embodiments, the offline ranker generates a candidate set of pairs comprising a member profile and a job postings using the inverted indices of key concepts, such that only those pairs that have a certain number of overlapping key concepts are included in the set. The offline ranker is also configured to compute features for pairs comprising a member profile and a job postings, generate offline relevance scores for pairs comprising a member profile and a job posting using the computed features, as well as to perform training, validation, and testing of one or more offline relevance models.

In some embodiments, the offline ranker is configured to perform feature computation incrementally. For example, after the initial execution of the workflow for generating features and relevance scores for pairs comprising a member profile and a job posting, the offline ranker recalculates the features and/or the relevance scores only with respect to those member profiles that have updated with respect to those job postings that have not been previously available in the online social network system.

The online ranker detects that a member represented by a subject member profile successfully performed login operations with respect to the online social network and, in response, generates a presentation set of job postings that are then displayed to the member. In order to generate a presentation set of job postings, the online ranker executes one of the online relevance models to compute online relevance scores for candidate job postings with respect to the subject member profile and then selects the presentation set based on the respective relevance scores. The online ranker uses values generated by the offline ranker (such as relevance scores and/or features) to generate online relevance scores.

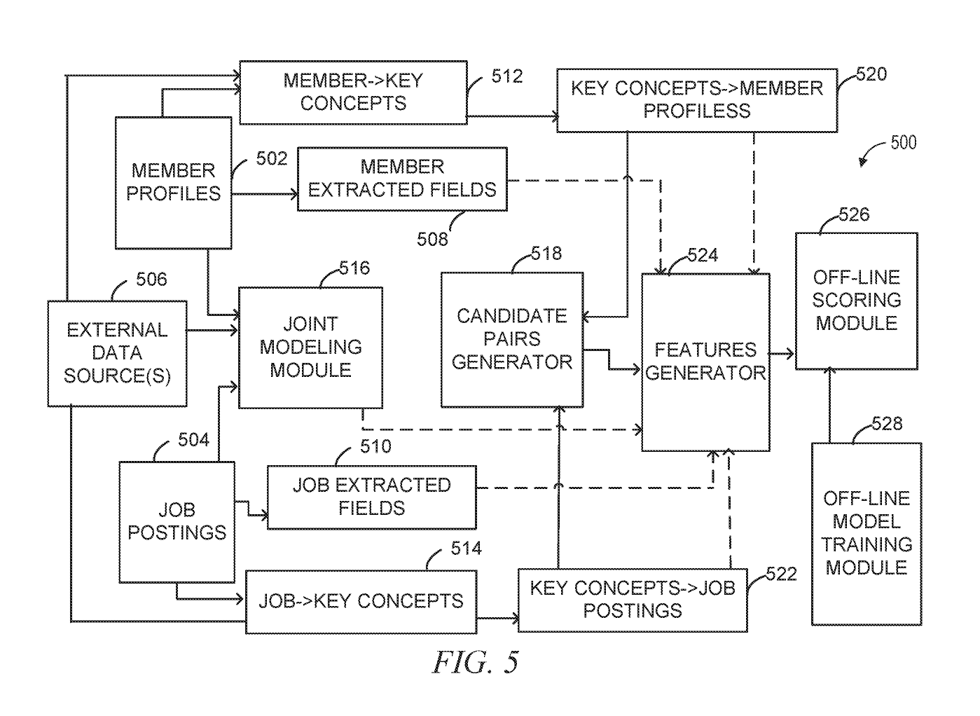

Example architecture 500 of an offline ranker, which is the offline component of the recommendation system that uses a hybrid ofifine/online approach for generating job recommendations for members in an online social network system, is shown in FIG. 5. The data sources 502 (member profiles), 504 (job postings), and 506 (external data sources such as, e.g., Wikipedia® eXtensible Markup Language (XML) Dump) are processed to derive key concepts. The member profiles 502 and the job postings 504 can be processed directly by extracting data from profile fields and job posting fields. Example fields of a member profile are education, experience, geographic location, industry, and skills. Job postings have fields that correspond directly or indirectly to one or more fields of member profiles. The data extracted from data from the profile fields and the job posting fields can be combined with data extracted from the external sources 506. External data may reveal additional correlation between the phrases that appear in member profiles and the job postings, as well as correlation between key concepts.

Blocks 508 and 510 are respective field data for member profiles and job postings. Blocks 512 and 514 are respective augmented field data for member profiles and job postings. Respective field data for member profiles and job postings is augmented with the key concepts derived using the external sources 506 and, optionally, with their relative importance values.

Block 516 is a joint modeling module. Starting with associations between member profiles and job postings, which can be generated based on previously monitored and collected historical data with respect to job applications and views by members, the joint modeling module 516 performs joint modeling using techniques such as, e.g., matrix factorization, topic models, and word embeddings. The joint modeling module 516 then uses the resulting representations to define rich features between member fields and job fields. The joint modeling module 516 may also be configured to represent member fields and job fields as part of a universal concept graph, and define graph-similarity-based features. The joint modeling module 516 is also configured to create mapping between member vocabulary and job vocabulary.

Blocks 520 and 522 are the member inverted index and the job inverted index described above. Block 518 is a candidate set generator. The candidate set generator 518 uses the member inverted index 520 and the job inverted index 522 to determine those job postings that can match a given member profile based on the key concept phrases that are mapped to both the subject member profile and the subject job posting. The candidate set generator 518 creates a candidate set of (member, job) pairs to be scored.

Block 524 is a features generator. The features generator 524 is configured to calculate features for (member, job) pairs, including potentially computationally expensive features derived using the representations generated using field data for member profiles and job postings (blocks 508 and 510), field data for member profiles and job postings augmented with key concepts by utilizing external sources (blocks 512 and 514), as well as representations generated by the joint modeling module 516. The features generator 524 generates features based on data from any combination of the sources 508, 510, 516, 520, and 522.

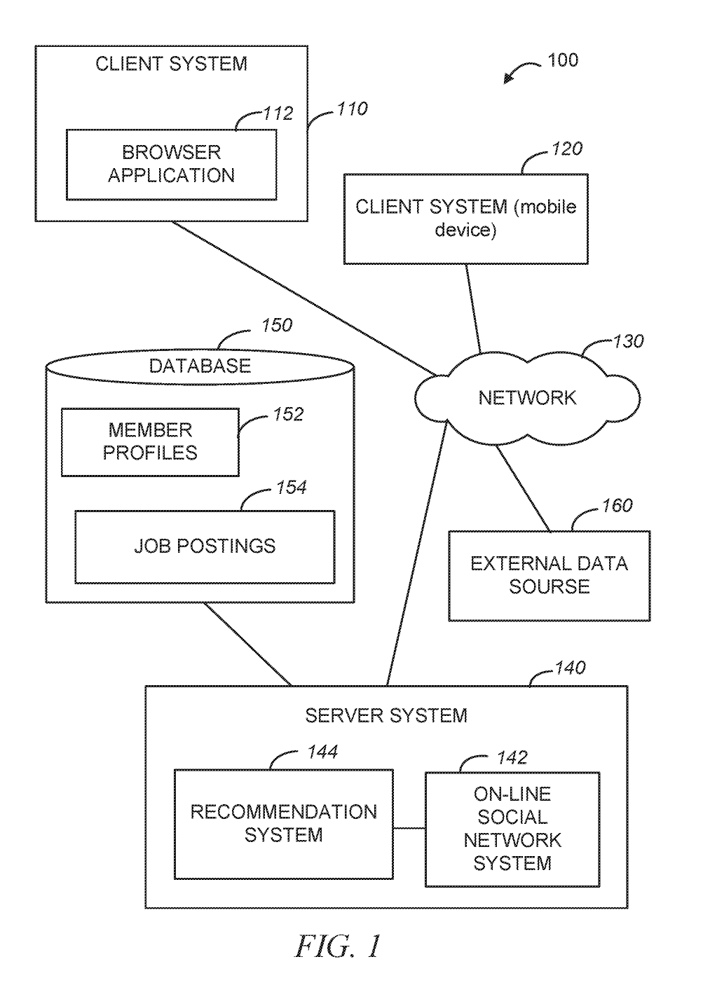

Block 526 is an offline scoring module (also referred to an offline relevance scores generator) that generates offline relevance scores for pairs comprising a member profile and a job posting, using an offline relevance model trained using an offline training module 528. An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an online social network system 142. As explained above, each member of an online social network is represented by a member profile that contains personal and professional information about the member and that may be associated with social links that indicate the member's connection to other member profiles in the online social network. Member profiles and related information may be stored in a database 150 as member profiles 152. The database 150 also stores job postings 154.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 is configured to assign/recommend job postings to member profiles using hybrid offline/online approach described herein. In sonic embodiments, the recommendation system 144 uses, in addition to field data from member profiles and job postings, data obtained from external data sources (such as, e.g., an external data source 160 that is not maintained or controlled by an entity other than the online social network system 142) to generate key concepts. As explained above, key concepts are phrases that represent characteristics of respective member profiles and job postings. Key concepts can be utilized to reduce the number of pairs of member profiles and job postings, for which the offline ranker generates offline relevance scores and also to perform comparisons between characteristics of member profiles and job postings (by calculating associated features). An example of an online social network system is LinkedIn& An example recommendation system, which corresponds to the recommendation system 144 is illustrated in FIG. 7

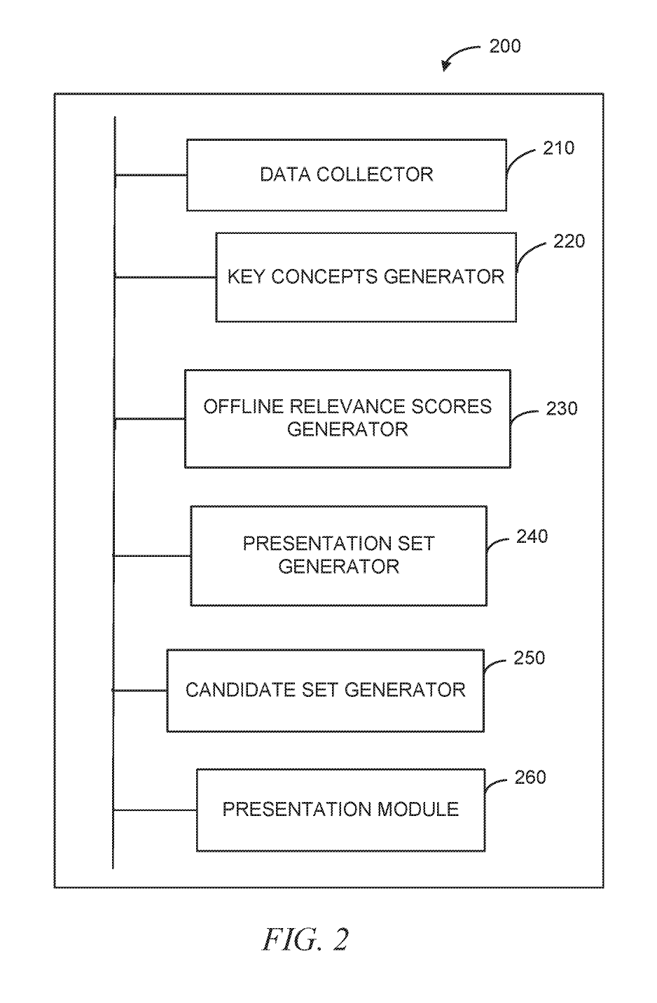

FIG. 2 is a block diagram of a system 200 to generate job recommendations using hybrid offline/online approach in the online social network system 142 of FIG. 1. As shown in FIG. 2, the system 200 includes a data collector 210, a key concepts generator 220, an offline relevance scores generator 230, a presentation set generator 240, a candidate set generator 250, and a presentation module 260.

The data collector 210 is configured to collect data that characterizes member profiles and job postings in the online social network system 142 of FIG. 1. The data collector 210 accesses field data that is present in member profiles and job postings, and also obtains data from one or more external sources that are maintained separately from the online social network system 142.

The key concepts generator 220 is configured to generate a set of key concepts using the data collected by the data collector 210. Each key concept from the set of key concepts is associated with a set of member references and/or with a set of job references. Each entry in the set of member references is associated with a member profile in the online social network system 142. Each entry in the set of job references is associated with a job posting in the online social network system 142. The key concepts generator is also configured to generate a member set of key concepts and a job set of key concepts. Each key concept from the member set of key concepts is associated with a set of member profiles that are characterized by that key concept. Each key concept from the job set of key concepts is associated with a set of job postings that are characterized by that key concept.

The offline relevance scores generator 230 is configured to generate, using the set of key concepts, offline relevance scores for pairs comprising a. member profile and a job posting. The offline relevance scores include so-called subject scores—relevance scores that are generated with respect to a subject member profile. In some embodiments, the offline relevance scores generator 250 is configured to generate the offline relevance scores only for those pairs comprising a member profile and a job posting where the member profile is associated with a certain number of key concepts that the job posting is also associated with.

The presentation set generator 240 is configured to access the subject scores generated with respect to the subject member profile in response to detecting that a member represented by the subject member profile is logged in into the online social network system, and to use the subject scores to generate a presentation set of job postings that is to be recommended to the subject member. The presentation set generator 240 generates the subject scores by executing an offline relevance model using features generated with respect to pairs comprising the subject member profile and a job posting, where a feature from the features generated with respect to the subject member profile and a particular job posting is a value that indicates a degree of similarity between a characteristic of the subject member profile and a corresponding characteristic of the particular job posting. One example of a feature generated with respect to the subject member profile and a particular job posting is a value that indicates a degree of similarity between a geographic location indicated in the subject member profile and a geographic location indicated in the particular job posting. Another example is a value that indicates a degree of similarity between an industry indicated in the subject member profile and an industry indicated in the particular job posting.

The candidate set generator 250 is configured to include a pair comprising a certain member profile and a certain job posting into the candidate set of pairs based on determining that a number of key concepts that are associated with the certain member profile and are also associated with the certain job posting is greater than a predetermined threshold value,

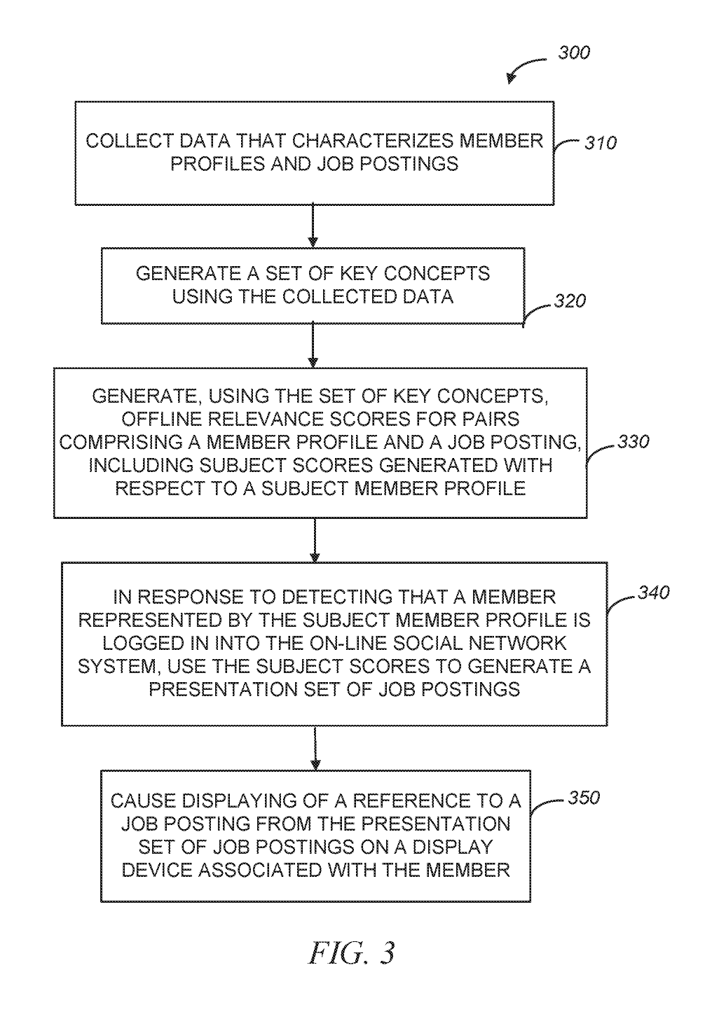

The presentation module 260 is configured to cause presentation, on a display device, of references to job postings included in the presentation set of job recommendations. Some operations performed by the system 200 may be described with reference to FIG. 3.

FIG. 3 is a flow chart of a method 300 to generate job recommendations using hybrid offline/online approach in the online social network system 142 of Fig. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server syste of FIG. 1, specifically, at the system 200 shown in

As shown in FIG. 3, the method 300 commences at operation 310, when the data collector 210 of FIG. 2 collects data that characterizes member profiles and job postings in the online social network system 142 of FIG. 1. The key concepts generator 220 of FIG. 2 generates a set of key concepts using the data collected by the data collector 210 at operation 320. The offline relevance scores generator 230 of FIG. 2 generates, using the set of key concepts, offline relevance scores for pairs comprising a member profile and a job posting at operation 330. At operation 340, in response to detecting that a member represented by the subject member profile is logged in into the online social network system 142, the presentation set generator 240 of FIG. 2 uses the subject scores to generate a presentation set of job postings that is to be recommended to the subject member. The presentation module 260 of FIG. 2 causes presentation, on a display device, of references to job postings included in the presentation set of job recommendations, at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

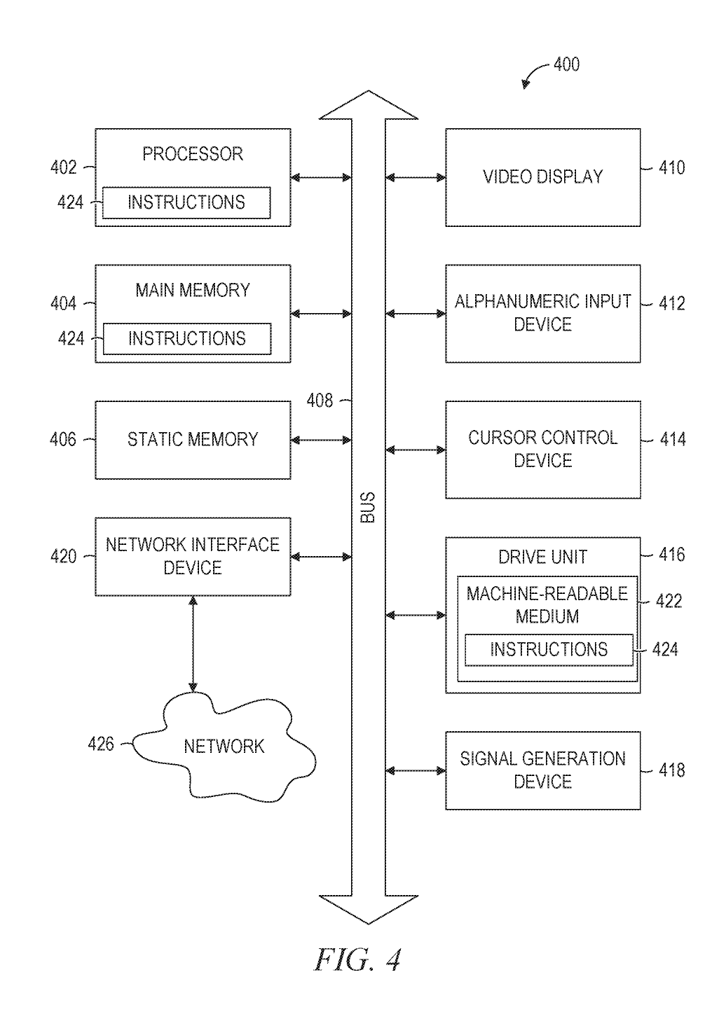

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular ephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk chive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions, The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, compise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate job recommendations using hybrid offline/online approach in an online social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
collecting data that characterizes member profiles and job postings in an online social network system;
using the collected data to generate a set of key concepts, each key concept from the set of key concepts associated with a set of member references and/or with a set of job references, each entry in the set of member references associated with a member profile in the online social network system, each entry in the set of job references associated with a job posting in the online social network system;
using the set of key concepts to generate offline relevance scores for pairs comprising a member profile and a job posting, the offline relevance scores comprising subject scores generated with respect to a subject member profile;
using at least one processor, accessing the subject scores generated with respect to the subject member profile in response to detecting that a member represented by the subject member profile is logged in into the online social network system, and using the subject scores to generate a presentation set of job postings; and
causing displaying of a reference to a job posting from the presentation set of job postings on a display device associated with the member.

2. The method of claim 1, wherein the collecting of data that characterizes member profiles and job postings in the online social network system comprises accessing field data in the member profiles and the job postings.

3. The method of claim 2, wherein the collecting of data that characterizes member profiles and job postings in the online social network system comprises accessing one or more external sources maintained separately from the online social network system.

4. The method of claim 1, comprising using the set of key concepts to generate a member set of key concepts, each key concept from the member set of key concepts associated with a set of member profiles.

5. The method of claim 4, comprising using the set of key concepts to generate a job set of key concepts, each key concept from the job set of key concepts associated with a set of job postings.

6. The method of claim 5, wherein the generating of the offline relevance scores is only for those pairs comprising a member profile and a job posting where the member profile is associated with a certain number of key concepts that the job posting is also associated with.

7. The method of claim 5, comprising selecting a candidate set of pairs comprising a member profile and a job posting, wherein the selecting comprises:
based on determining that a number of key concepts that are associated with a certain member profile and are also associated with a certain job posting is greater than a predetermined threshold value, including a pair comprising the certain member profile and the certain job posting into the candidate set of pairs.

8. The method of claim 1, wherein the generating of the subject scores with respect to the subject member profile comprising executing an offline relevance model using features generated with respect to pairs comprising the subject member profile and a job posting, a feature from the features generated with respect to the subject member profile and a particular job posting is a value that indicates a degree of similarity between a characteristic of the subject member profile and a corresponding characteristic of the particular job posting.

9. The method of claim 8, wherein a feature from the features generated with respect to the subject member profile and a particular job posting is a value that indicates a degree of similarity between a geographic location indicated in the subject member profile and a geographic location indicated in the particular job posting.

10. The method of claim 1, comprising storing the subject scores in a key-value store as associated with the subject member profile.

11. A computer-implemented system comprising:
a data collector, implemented using at least one processor, to collect data that characterizes member profiles and job postings in an online social network system;
a key concepts generator, implemented using at least one processor, to generate a set of key concepts using the collected data, each key concept from the set of key concepts associated with a set of member references and/or with a set of job references, each entry in the set of member references associated with a member profile in the online social network system, each entry in the set of job references associated with a job posting in the online social network system;
an offline relevance scores generator, implemented using at least one processor, to generate, using the set of key concepts, offline relevance scores for pairs comprising a member profile and a job posting, the offline relevance scores comprising subject scores generated with respect to a subject member profile;
a presentation set generator, implemented using at least one processor, to access the subject scores generated with respect to the subject member profile in response to detecting that a member represented by the subject member profile is logged in into the online social network system, and to use the subject scores to generate a presentation set of job postings; and
a presentation module, implemented using at least one processor, to cause displaying of a reference to a job posting from the presentation set of job postings on a display device associated with the member.

12. The system of claim 11, wherein the data collector collects data that characterizes member profiles and job postings in the online social network system comprises accessing field data in the member profiles and the job postings.

13. The system of claim 12, wherein the data collector is to access one or more external sources maintained separately from the online social network system.

14. The system of claim 11, wherein the key concepts generator is to generate a member set of key concepts using the set of key concepts, each key concept from the member set of key concepts associated with a set of member profiles.

15. The system of claim 14, wherein the key concepts generator is to generate a job set of key concepts using the set of key concepts, each key concept from the job set of key concepts associated with a set of job postings.

16. The system of claim 15, wherein the offline relevance scores generator is to generate the offline relevance scores only for those pairs comprising a member profile and a job posting where the member profile is associated with a certain number of key concepts that the job posting is also associated with.

17. The system of claim 15, comprising a candidate set generator, implemented using at least one processor, to include a pair comprising a certain member profile and a certain job posting into the candidate set of pairs based on determining that a number of key concepts that are associated with the certain member profile and are also associated with the certain job posting is greater than a predetermined threshold value.

18. The system of claim 11, wherein the presentation set generator is to generate the subject scores with respect to the subject member profile by executing an offline relevance model using features generated with respect to pairs comprising the subject member profile and a job posting, a feature from the features generated with respect to the subject member profile and a particular job posting is a value that indicates a degree of similarity between a characteristic of the subject member profile and a corresponding characteristic of the particular job posting.

19. The system of claim 18, wherein a feature from the features generated with respect to the subject member profile and a particular job posting is a value that indicates a degree of similarity between a geographic location indicated in the subject member profile and a geographic location indicated in the particular job posting.

70. A machine-readable non-transitory storage medium having instruction data executable by a machine to cause the machine to perform operations comprising:
collecting data that characterizes member profiles and job postings in an online social network system;
using the collected data to generate a set of key concepts, each key concept from the set of key concepts associated with a set of member references and/or with a set of job references, each entry in the set of member references associated with a member profile in the online social network system, each entry in the set of job references associated with a job posting in the online social network system;
using the set of key concepts to generate offline relevance scores for pairs comprising a member profile and a job posting, the offline relevance scores comprising subject scores generated with respect to a subject member profile;
accessing the subject scores generated with respect to the subject member profile in response to detecting that a member represented by the subject member profile is logged in into the online social network system, and using the subject scores to generate a presentation set of job postings; and
causing displaying of a reference to a job posting from the presentation set of job postings on a display device associated with the member.
